(19) United States
(12) Patent Application Publication
(10) Pub. No.: US 2024/0022075 A1
(43) Pub. Date: Jan. 18, 2024

(54) CHARGING PLAN RESCHEDULING RESPONSIVE TO DYNAMICALLY CHANGING CONDITIONS

(71) Applicant: Wireless Advanced Vehicle Electrification, LLC, Salt Lake City, UT (US)

(72) Inventor: Steven Ball, Sandy, UT (US)

(21) Appl. No.: 17/865,372

(22) Filed: Jul. 14, 2022

(51) Int. Cl. H02J 3/28; G06Q 50/06; B60L 53/66; H02J 13/00

(52) U.S. Cl. CPC H02J 3/28; G06Q 50/06; B60L 53/665; H02J 13/00002

(57) ABSTRACT

Techniques for managing energy usage plans of network components that are associated with energy storage systems are described herein. Energy usage plans may be based upon calculated anticipated energy needs of the network components. In one embodiment, an initial energy usage plan may define initial configurations of the network components. In case of detected disruption, the initial configurations of the network components may be dynamically adjusted based upon recalculated anticipated energy needs at the time of the detected disruption.

### BACKGROUND

With ever-increasing developments in vehicular technologies, electric vehicles have shown rapid improvement in battery performance, motor performance, and control system optimization. The developments have focused on extending driving range, battery storage, and/or battery life, for example. Other developments also include the ability to charge stations to support energy requirements of electric vehicles.

In addition, with a rapid increase in production, corresponding problems of planning and constructing facilities for the charging stations have attracted extensive attention in many circles, including some negative attention due to shortages of charging facilities and their efficiencies, which diminish customer satisfaction as electric vehicles gain popularity.

### BRIEF DESCRIPTION OF THE DRAWINGS

The detailed description is described with reference to the accompanying figures, in which the left-most digit(s) of a reference number identifies the figure in which the reference number first appears. The use of the same reference numbers in different figures indicates similar or identical items.

FIG. 1 is a block diagram of an example energy distribution network in which management of energy usage plans of network components that are associated with energy storage systems can be implemented, in accordance with at least one embodiment.

FIG. 2 is a flow diagram of an example methodological implementation for managing the energy usage plans of the energy storage systems in the energy distribution network, in accordance with at least one embodiment.

FIG. 3 is a flow diagram of an example methodological implementation for generating an energy usage plan for a particular energy storage system, in accordance with at least one embodiment.

FIG. 4 is a flow diagram of an example methodological implementation for adjusting the energy usage plan using stored parameter measurement thresholds, in accordance with at least one embodiment

FIG. 5 is a block diagram of an example implementation of energy transfers between network components, in accordance with at least one embodiment.

FIG. 6 is a block diagram of an example energy management server that can facilitate the management of the energy usage plans throughout the energy distribution network, in accordance with at least one embodiment.

### DETAILED DESCRIPTION

### Overview

This disclosure is directed to techniques for managing energy usage plans of network components that are associated with energy storage systems in an energy distribution network. Energy usage plans may include desired configurations of the associated energy storage systems based upon their corresponding anticipated energy needs and charging plan schedules for the energy storage systems to support the anticipated energy needs. The anticipated energy needs may include projected use of the energy storage systems (e.g., one or more batteries) to support energy requirements of associated electric vehicles or charging stations such as, without limitation, an ability of the electric vehicles to provide energy to other electric vehicles, provide backup power to sustain critical loads, store energy when grid prices are low then selling the stored energy when grid prices are high, and the like. As described herein, the energy storage systems may also refer to the associated network components. For example, configuring an energy storage system may also mean configuring a network component that is associated with the energy storage system.

The energy distribution environment may include, by way of illustration and not limitation, the network components such as energy providing components and energy consuming components. Energy providing components may include fixed charging stations, mobile charging stations, electric vehicles when configured as energy providing components, and/or dedicated energy providing electric vehicles that can be charged to supply energy to the energy consuming components. Energy consuming components (or energy consuming devices) may include electric vehicles or mobile charging stations that can be configured to receive energy from the energy providing components.

In one embodiment, a network manager may manage a plurality of network components that may comprise any one or more of a group of charging stations (i.e., energy providing components) or electric vehicles (i.e., energy consuming components) throughout the energy distribution network. Each of the charging stations may provide energy transfers via an electric grid source, an energy producing source (e.g., a diesel-driven electric generator), and/or the energy storage system that includes the use of one or more batteries. In some embodiments, an electric vehicle may be configured to provide energy transfers through its batteries i.e., energy storage systems. In this embodiment, the network manager may establish a first energy usage plan that can define a desired initial configuration of the electric vehicles or the charging stations that are associated with corresponding energy storage systems.

By way of illustration and not limitation, the network manager may establish the first energy usage plan based upon determined anticipated energy needs of a particular electric vehicle during an energy usage operating period. The energy usage operating period may include an operating cycle for completing the anticipated energy needs and can include an hourly cycle, daily cycle, weekly cycle, or other cycles that may be selected by the network manager. In one non-limiting embodiment, the network manager may receive data information of a particular electric vehicle and further obtains environmental data from third-party servers. The data information may include current geolocation of the particular vehicle, its destination point, current capacity, and battery parameters. The environmental data may include characteristics of the surrounding conditions such as weather reports, traffic reports, third-party news reports, social media posting, holiday events, sporting events, or the like, which describe a disposition of a surrounding environment and real-time events that are occurring proximate to or within a particular distance to the current geolocation or projected path of the particular electric vehicle where the stored energy may be needed. n this embodiment, the network manager may use the data information and the environmental data as an input to an algorithm to output the anticipated energy needs of the particular electric vehicle.

With the determined anticipated energy needs, the first energy usage plan may be generated. For example, the anticipated energy needs correspond to certain desired configurations of the particular vehicle, and accordingly, the energy usage plan may be generated by the network manager to define these configurations together with preconfigured charging plan schedules to obtain the anticipated energy needs.

Upon configuration by the network manager of the particular electric vehicle based upon the first energy usage plan, the network manager may monitor for conditions that can disrupt the first energy usage plan. For example, the conditions may include unexpected traffic delays that disrupt the ability of the particular electric vehicle to exchange energy with another electric vehicle according to the first energy usage plan. In this example, the network manager may generate a second energy usage plan that is based upon the redetermined anticipated energy needs at the time of the disruption and for the remainder of an operating period of the first energy usage plan. In one embodiment, the second energy usage plan may implement new configurations in the energy storage system of the particular electric vehicle. For example, the new configurations may include a different capacity and/or a rescheduling of the charging plan. In this embodiment, the second energy usage plan may implement a dynamic reconfiguration of the energy storage systems based upon dynamically changing conditions.

Details regarding the novel techniques referenced above are presented herein are described in detail, below, with respect to several figures that identify elements and operations used in systems, devices, methods, and computer-readable storage media that implement the techniques.

### Example Energy Distribution Network

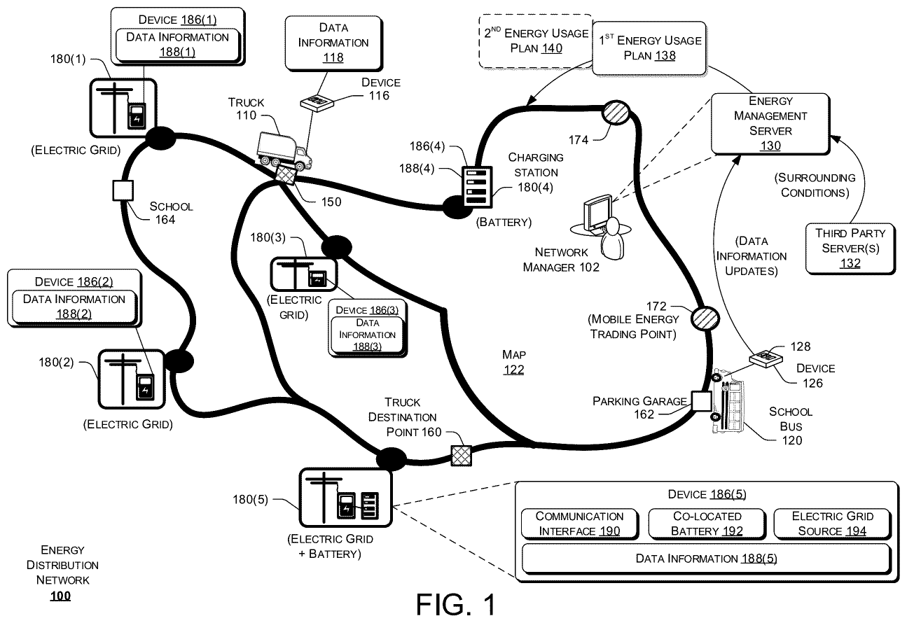

FIG. 1 is a diagram of an example energy distribution network 100 in which a concept of managing the energy usage plans for the network components can be implemented. In one embodiment, an energy management server may generate energy usage plans of the network components based upon calculated anticipated energy needs of the network components. The anticipated energy needs may be inferred from data information of the network components and corresponding detected characteristics of surrounding conditions that can be received from third-party servers. Upon configuration of the network components based upon the first energy usage plan, the energy management server may detect conditions that can trigger an adjustment of the first energy usage plan to create a second energy usage plan. The second energy usage plan may be based upon recalculated anticipated energy needs at the time of the detected condition. The second energy usage plan may be implemented to ultimately complete the anticipated energy needs in the first energy usage plan. This technique of dynamically adjusting the energy usage plans may improve efficiency of energy management operations in the energy distribution network 100.

As shown, the energy distribution network 100 may include a network manager 102 that can manage the energy usage plans of the energy storage systems in the energy providing components and energy consuming components such as, by way of illustration and not limitation, a truck 110, school bus 120, and charging stations 180(4)-180(5). Charging stations 180(1)-180(3) operate on electric grid sources only and can be managed to charge, via the electric grid sources, the energy storage systems of the electric vehicles, co-located batteries, and mobile charging stations. As those skilled in the art will appreciate, the truck 110 and the school bus 120 may be treated as mobile energy consuming components that render transportation services over various locations as illustrated by map 122. In one example, the truck 110 may provide delivery services from its current location 150 to a truck destination point 160 while an itinerary of the school bus 120 may include driving from a parking garage 162 to a school (geolocation) 164. The truck 110 may be associated with a device 116 and data information 118 while the school bus 120 may be associated with a device 126 and data information 128. The devices 116, 126 may include an embedded electronic computer unit (ECU) or other system processors that can establish communications with the network manager 102 for purposes of transmitting data information updates such as, e.g., current geolocations, destination points, current capacities, etc. Data information 118, 128 may store current configurations of the corresponding electric vehicles and data that can be gathered via sensors of the electric vehicles.

The charging stations 180(1)-180(5) may be treated as energy providing components that can be disposed at different geolocations on the map 122. The charging stations 180(1)-180(5) may be associated with corresponding devices 186(1)-186(5), which are associated with data information 188(1)-188(5), respectively. Devices 186(1)-186(5) may include system processors that can establish communications with the network manager 102 for purposes of transmitting data information updates such as current geolocation for mobile charging stations, current capacity, configurations of the electric grids, etc. Data information 188(1)-188(5) may store charging station information such as, without limitation, current capacities, geolocations, identifications, etc.

In one example, the charging stations may include a fixed charging station with an electric grid source only (e.g., charging stations 180(1)-180(3)), a charging station with a battery only (e.g., charging station 180(4)), or a fixed charging station with an electric grid source and a co-located battery (e.g., charging station 180(5)). The charging station 180(4) that includes the battery (and without electric grid source) may be positioned in a permanent location or implemented as a mobile charging station, such as a mobile container—i.e., a charging station that can be positioned at different geolocations. Each of the charging stations 180(1)-180(5) may include communication interfaces, co-located batteries, and/or electric grid sources. Without limitation, the charging station 180(5) may include, for example, a communication interface 190, a co-located battery 192, and an electric grid source 194. The communication interface 190 may be used to transmit to the network manager 102 the data information updates such as current configurations of the co-located battery 192 and the electric grid source 194, geolocations of the charging station 180(5), amount of energy consuming devices to serve within a particular operating period, and the like.

For purposes of illustration, only two electric vehicles (i.e., truck 110 and school bus 120) and five charging stations (i.e., charging stations 180(1)-180(5)) are shown. However, other network components or nodes such as vans, buses, trains, cars, dedicated mobile battery containers, or fixed charging stations may be added without affecting the embodiments described herein. In addition, the embodiments described below for managing energy usage plans of the electric vehicles may be similarly applied to the energy storage systems of the charging stations.

In one example, the network manager 102 may utilize one or more servers such as an energy management server 130 to manage the energy usage plans of the energy storage systems associated with one or more of the truck 110, school bus 120, charging station 180(4), and charging station 180(5). The energy management server 130 may also be used to manage distributions of available energy by the electric grid sources in one or more of the charging stations 180(1), 180(2), 180(3), and 180(5). The energy management server 130 may control and operate the network components in the energy distribution network 100.

In one instance, the energy management server 130 may receive the environmental data or characteristics of the surrounding conditions from third-party servers 132. The characteristics of the surrounding conditions may include third-party news reports, social media posting, weather reports, traffic reports, holiday events, or the like, which describe a disposition of a surrounding environment and real-time events that are occurring proximate or within a particular distance to a current or projected geolocation of the electric vehicles where stored energy may be needed for energy transfer. For example, the environmental data may include a heavy traffic report within one mile or a certain distance from the current geolocation of an electric vehicle. In this example, the energy management server 130 may use the heavy traffic report and data information of the electric vehicle to calculate or update its anticipated energy needs.

The truck 110 and the school bus 120 may include usable batteries for, e.g., energy storage systems and locomotion. In some cases, the truck 110 and the school bus 120 can be propelled by one or more electric motors that use batteries, or in combination with internal combustion engines in the case of hybrid vehicles. Each of these vehicles may include a vehicle identification number (VIN) that is unique for each vehicle, embedded sensors, navigation applications to identify GPS location, and other applications that may be installed in the vehicle. The vehicle batteries (not shown) of truck 110 and the school bus 120 may include one or more rechargeable batteries such as lithium-ion batteries. The vehicle battery or batteries may be associated with parameters such as maximum and minimum operating voltages, maximum self-charge, a state-of-charge indicator that can indicate a level of charge of the battery relative to its capacity and discharging rates. These parameters may be configurable to maintain, for example, a target state-of-charge level that corresponds to an amount of energy that, at any given moment, indicates how much energy is needed to complete a task (i.e., anticipated energy usage) in conjunction with a current energy usage plan. The vehicle battery parameters, VIN, and other electric vehicle configurations and information may be stored in the data information 118 and 128 of the truck 110 and the school bus 120, respectively.

As described herein, the electric vehicles (e.g., truck 110 or school bus 120) may be treated as mobile energy consuming components or mobile energy providing components depending upon their respective configurations as defined in a current energy usage plan. For example, in the initial energy usage plan, the truck 110 may be treated as a first mobile energy consuming component when it receives energy from a first energy providing component, e.g., charging station 180(3). However, upon an adjustment of the initial energy usage plan, or according to the initial energy plan, the same first mobile energy consuming component, i.e., truck 110, may be treated as an energy providing component when it is instructed to share its energy to the school bus 120. In this adjusted energy usage plan, the second energy providing component, i.e., truck 110 is also the first mobile energy consuming component in the initial energy usage plan.

The charging stations 180(1)-180(5) (or collectively referred to as charging stations 180) may be treated as energy providing components that are configured to transfer energy to energy consuming components. The charging stations 180 may include batteries, electric grid sources, co-located batteries, or a combination of any of these, each configured to at least conduct energy transfer services. In one example, the charging station 180(4) may be associated with a battery only. In another example, the charging station 180(5) may include the co-located battery 192 to provide backup power and support the electric grid source 194 in times of emergency like unavailability of the electric grid source, a spike in electric energy prices, or the like. The co-located battery 192 may receive energy from the electric grid source 194 of the same charging station and/or from the truck 110 or school bus 120 that can be also configured as energy providing components. The battery of the charging station 180(4) or the co-located battery 192 of the charging station 180(5) may be associated with parameters such a maximum or minimum operating voltage, state-of-charge, capacity, and discharging rates. These parameters may be configurable to maintain, for example, a target capacity or state-of-charge level that corresponds to an amount of energy that, at any given moment, indicates how much energy is needed in conjunction with the current energy usage plan. The battery parameters, co-located battery parameters, charging station identification, information about pairing between the co-located battery and electric grid source in one charging station, and other charging station information may be stored in the corresponding data information 188(01-188(5) of the charging stations 180(1)-180(5).

The energy management server 130 may include general-purpose computers, network servers, and/or other electronic devices that are capable of receiving input data, processing the input data, and generating output data. The input data may include one or more parameter measurements from the data information updates such as geolocation of the network component, current capacity, destination point, and the like. The input data may also include the environmental data from the third-party servers 132 that can include the characteristics of the surrounding conditions during the energy usage operating period. Based upon the input data, the output data may include the anticipated energy needs for each of the network components.

In one embodiment, the energy management server 130 may use the determined anticipated energy needs as a reference to generate a first energy usage plan 138, which defines initially the configurations of the network components. In case of monitored disruptions in the current energy usage plan as described herein, the energy management server 130 may recalculate the anticipated energy needs at the time of disruption and use the recalculated anticipated energy needs as a reference to generate a second energy usage plan 140. The second energy usage plan 140 may implement new configurations in the network components. In some embodiments, the new configurations may be implemented to affected network components only.

The energy distribution network 100 further depicts mobile energy trading points 172 and 174 that may include preconfigured geolocations for the electric vehicles and/or mobile charging stations to meet and perform energy transfer. In one example, the energy usage plan such as the first energy usage plan 138 or the second energy usage plan 140 may define the geolocations of the mobile energy trading points 172 and 174. The preconfigured geolocations of the mobile energy trading points 172 and 174 may provide geolocations to perform the energy transfers in the energy distribution network 100. For example, the first energy usage plan 138 may include a charging plan schedule that requires relocation of the truck 110 and the school bus 120 at the mobile energy trading point 172 to perform an energy transfer. In case of disruption of the first energy usage plan 138, the second energy usage plan 140 may include a rescheduled charging plan that can require the truck 110 and the school bus 120 to relocate at the mobile energy trading point 174 to perform a different energy transfer.

In an example embodiment of managing the energy usage plans, the energy management server 130 may receive from one or more energy consuming components their corresponding data information that includes, without limitation, their geolocations, destinations, plan to transfer or share energy, state-of-charge levels, or other data that can be gathered from their embedded sensors. The energy management server 130 may also receive from third party sources, as illustrated by the third-party servers 132, the corresponding environmental data based upon the current geolocations or projected route of the network components. In this embodiment, the energy management server 130 may infer from the data information and the surrounding conditions (i.e., environmental data) the anticipated energy needs of the energy consuming components for a particular energy usage operating period, which can include an operating cycle for the completion of the projected/anticipated energy needs.

For example, the truck 110 may be preconfigured to travel towards the truck destination point 160 to share a preconfigured amount of energy with another electric vehicle. In this example, the truck 110 may send to the energy management server 130 data information 118 that includes its current geolocation 150, the truck destination point 160, preconfigured amount of energy to transfer to the other electric vehicle, current capacity, current load, and other data that are related to truck 110's energy consumptions. The energy management server 130 may then interrogate the third-party servers 132 to send the environmental data based upon the current geolocation and/or projected route of the truck 110 over a particular operating period. The environmental data may include the characteristics of the surrounding conditions such as third-party news reports, social media postings, weather reports, traffic conditions, sporting events, holiday events, or the like, which describe the disposition of a surrounding environment and the real-time events that are proximate to or near the current geolocation or projected route of the network component. With these input data, the energy management server 130 may use an algorithm to infer the anticipated energy needs of the truck 110.

For example, the energy management server 130 may infer from the received data information of the truck 110 that an energy of 100 kW may be required to reach the truck destination point 160 based upon the received state-of-charge level of the truck 110, current geolocation, distance to the truck destination point 160, amount of energy to transfer to the other electric vehicle, and amount of load. Further, the energy management server 130 may infer an additional amount of 50 kW of energy to compensate for a projected delay of two hours over a projected route (i.e., environmental data). In this example, the energy management server 130 may infer an anticipated energy need of 150 kW (i.e., 100 kW+50 kW=150 kW) for the truck 110 to reach the truck destination point 160 and transfer energy to the other electric vehicle. The anticipated energy needs of 150 kW may then be used as a reference to generate the first energy usage plan 138. For example, the first energy usage plan 138 may require the truck 110 to have a charging plan schedule that includes charging a total amount of 150 kW at one or more charging stations along the projected route. In another example, the first energy usage plan 138 may require the truck 110 to maintain a certain amount of state-of-charge level, and the like. In these examples, the first energy usage plan 138 may define the desired configurations of the truck 110 and the charging plan schedules to obtain the determined anticipated energy needs.

With the generated first energy usage plan 138, the energy management server 130 may send notifications to corresponding network components. The notifications may include control signals or instructions as to amount of energy to charge or discharge, targeted capacity or state-of-charge level to maintain, preconfigured charging plan schedules, relocation to a mobile energy trading point, or other desired configurations of the network components.

Upon configuration of the network components based on the initial energy usage plan, the energy management server 130 may monitor conditions that can trigger the need for adjustments of the first energy usage plan 138, resulting in an updated, second energy usage plan 140. By way of illustration and not limitation, the monitored conditions may disrupt the anticipated energy needs in the first energy usage plan 138 that includes initial desired capacity or a state-of-charge level, initial preconfigured charging plan schedules, and the like. In this illustration, the disruption may cause an incompletion of the anticipated energy needs of the energy storage systems in the first energy usage plan 138. Accordingly, the energy management server 130 may recalculate the anticipated energy needs at the time of disruption and generate the second energy usage plan 140 based upon the recalculated anticipated energy needs to ultimately complete the targeted energy needs in the first energy usage plan 138.

Following the example above where the energy management server 130 may infer the anticipated energy needs of 150 kW (i.e., 100 kW+50 kW=150 kW) for the truck 110 to reach the truck destination point 160 and transfer energy to the other electric vehicle, an unanticipated weather conditions, events, traffic reports, or the like, may affect the inferred anticipated energy needs of 150 kW. In this regard, the energy management server 130 may recalculate the anticipated energy needs based on the data information and the environmental data at the time of the disruption.

### Example Implementation of Managing Energy Usage Plans

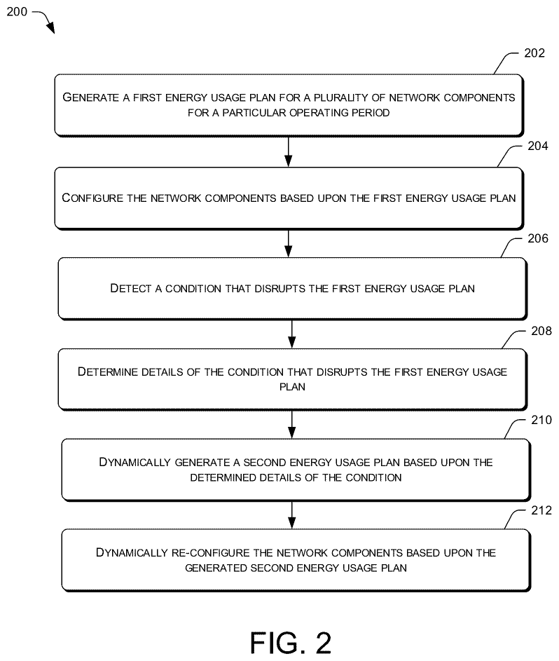

FIG. 2 is a flow diagram 200 that depicts a methodological implementation of a technique for managing the energy usage plans of the energy storage systems in the energy distribution network 100. In the following discussion of FIG. 2, continuing reference is made to the elements and reference numerals shown in and described with respect to the energy management server 130 of FIG. 1.

At block 202, the energy management server 130 may generate a first energy usage plan for a plurality of network components for a first energy usage operating period. In one example, the energy management server 130 may generate the first energy usage plan 138 for the energy storage systems of the network components such as the truck 110, school bus 120, and the charging stations 180(4)-180(5) for a first energy usage operating period. The energy management server 130 may use the data information of each of these network components and the corresponding characteristics of the surrounding conditions to infer their respective anticipated energy needs. In one embodiment, the first energy usage operating period may include a time period or operating cycle for the network components to complete their anticipated energy needs.

At block 204, the energy management server 130 may facilitate the configuration of the network components that are associated with energy storage systems based upon a generated first energy usage plan. In one embodiment, each of the network components may be configured based upon their corresponding anticipated energy needs.

Following the example above in FIG. 1, the anticipated energy needs for the truck 110 may require charging 150 kW of energy to reach the destination point and to share a particular amount of energy to another electric vehicle at the destination point. In this example, a configuration of the electric vehicle based upon the anticipated energy needs may include a charging plan schedule of charging a total of at least 150 kW of energy at one or more charging stations in order to reach the destination point and share the particular amount of energy to the other electric vehicle.

In another example, the anticipated energy needs for the charging stations 180(4)-180(5) may include supplying a total of at least 1200 kW of energy to mobile energy consuming components during an energy usage operating period of 24 hours. In this example, the configuration of each of the charging stations 180(4)-180(5) based upon this anticipated energy needs may include supplying of energy at an average rate of 50 kW per hour (i.e., 1200 kW divided by 24 hours equals 50 kW per hour). In one embodiment, the energy management server 130 may send control signals to the network components and their respective devices may be used to implement the desired configurations based upon the first energy usage plan.

At block 206, the energy management server 130 may detect a condition that can disrupt the first energy usage plan during the first energy usage operating period. In one example, the first energy usage plan 138 may be disrupted by an occurrence or absence of an event, or other forms that can cause deviations in the desired configurations based on the first energy usage plan 138. The disruption may cause the network components to reasonably with the anticipated energy needs according to the first energy usage plan. In this example, the energy management server 130 may detect the condition by monitoring the data information of each network component or the environmental data from the third-party servers. The monitoring may be continuous or periodic such as per minute, hour, etc.

At block 208, the energy management server 130 may determine details of the condition that disrupts the first energy usage plan. In one embodiment, the energy management server 130 may parse the received data information or environmental data to identify the details of the disruption.

For example, the details of the received data information may include inability of the electric vehicle to share a particular amount of energy to another electric vehicle at the destination point. The inability, for example, may be caused by an unanticipated traffic condition that disrupts the capacity of the electric vehicle upon its arrival at the destination point. In another example, the received data information may include the charging station 180(4) that has been discharging energy at more than the discharge energy measurement threshold. In this other example, a parameter measurement threshold such as the average rate of 50 kW per hour in the above example may be used to detect the disruptions.

At block 210, the energy management server 130 may dynamically generate a second energy usage plan for the remainder of the operating period based upon the first energy usage plan, the remaining anticipated usage, and the determined details of the received information. In one example, the energy management server 130 may recalculate the anticipated energy needs of the affected energy storage systems upon the occurrence of the disruption, and use the recalculated anticipated energy needs to generate the second energy usage plan 140. In one instance, the second energy usage plan 140 may be applied particularly to the network components that are associated with the affected energy storage systems.

At block 212, the energy management server 130 may dynamically reconfigure the network components in the energy distribution network based upon the generated second energy usage plan. In one example, the dynamic reconfiguration may include the reconfiguration of the one or more network components that are associated with the affected energy storage systems.

### Example Implementation of Generating an Energy Usage Plan

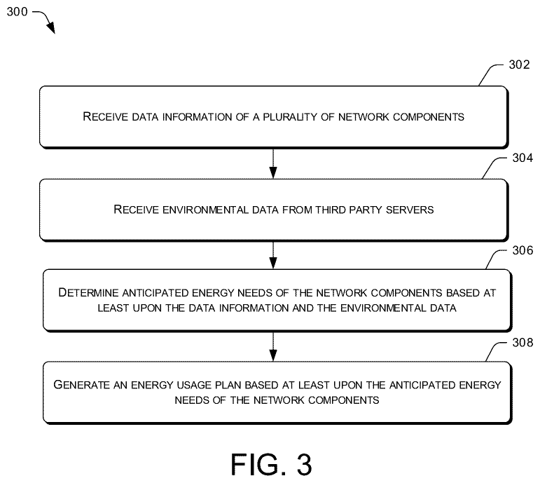

FIG. 3 is a flow diagram 300 that depicts a methodological implementation of a technique for generating an energy usage plan for the network components in the energy distribution network 100.

At block 302, the energy management server 130 may receive data information of a plurality of network components. The data information of each network component may include, for example, geolocations, current capacity, amount of energy to share, destination point, and the like.

At block 304, the energy management server 130 may receive environmental data from third-party servers. For example, the third-party servers 132 may transmit current and projected characteristics of surrounding conditions to the energy management server 130. The characteristics of surrounding conditions may include projected traffic and weather conditions, time of day, day of the week, presence of holidays, energy fluctuation rates, and other environmental data that describe the disposition of a surrounding environment and the real-time events that are proximate to the current geolocation or projected route of the corresponding network component.

At block 306, the energy management server 130 may infer the anticipated energy needs of the network components based upon the received data information and environmental data. In one example, the energy management server 130 may use an algorithm to calculate the anticipated energy needs based upon the received data information and the environmental data. The one or more algorithms may include the use of mathematical functions like linear programming, or a prediction model such as K-mean algorithms, maximum likelihood algorithms, Random Forest algorithms, etc

At block 308, the energy management server 130 may generate an energy usage plan based at least upon the anticipated energy needs. In one example, the generated energy usage plan may indicate the desired configurations of the network components based upon the inferred anticipated energy needs. In another example, the generated energy usage plan may indicate the charging plan schedules or rescheduled charging plans to obtain the inferred anticipated energy needs.

### Example Implementation of Adjusting the Current Energy Usage Plan

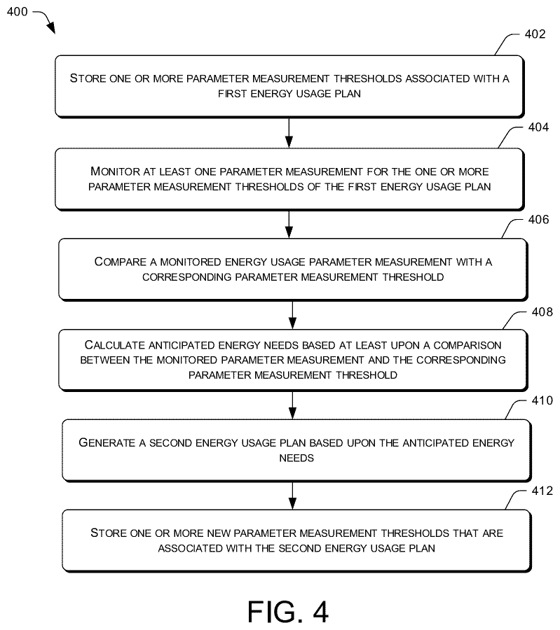

FIG. 4 is a flow diagram 400 that depicts a methodological implementation of adjusting the energy usage plan using stored parameter measurement thresholds to detect the disrupting or triggering conditions.

At block 402, the energy management server 130 may store one or more parameter measurement thresholds that can be associated with a first energy usage plan. In one embodiment, the parameter measurement thresholds may be based upon the anticipated energy needs of the network components. In this embodiment, the parameter measurement thresholds may include reference values that can be used to determine disruptions of the first energy usage plan.

For example, by way of illustration and not limitation, the mobile charging station 180(4) may be configured to have an average discharging rate of 50 kW per hour based upon its anticipated energy needs of supplying at least 1200 kW of energy to mobile energy consuming components for an energy usage operating period of 24 hours. In this example, the configured average discharging rate of 50 kW per hour (i.e., 1200 kW divided by 24 hours equals 50 kW per hour) may be stored and used as a discharge rate measurement threshold to detect conditions that can trigger an adjustment of the first energy usage plan. In another example, the parameter measurement threshold may include minimum amount of charge to maintain, charging plan schedule to observe, geolocation at a particular time period, amount of energy to transfer at a certain geolocation and/or time period, or other parameter that can be used to provide the anticipated energy needs of the network component.

At block 404, the energy management server 130 may monitor at least one parameter measurement for the one or more parameter measurement thresholds of the first energy usage plan. Following the example in block 402 above, the energy management server 130 may monitor the discharge rate measurement of the mobile charging station 180(4) over a predetermined time period during the energy usage operating period. The predetermined time period may include a portion of the predetermined energy usage operating period and can have unit values of minutes, hours, etc. For example, the energy management server 130 monitors the discharge rate measurement at the end of 10 hours as the predetermined time period. In this example, the energy management server 130 may measure the discharge rate measurement for purposes of detecting the disruption as described herein.

At block 406, the energy management server 130 may compare the monitored parameter measurement with a corresponding parameter measurement threshold value associated with the first energy usage plan. Following the example in block 404, the mobile charging station 180(4) may be monitored to confirm a discharge rate measurement of 700 kW of energy within the predetermined time period of 10 hours in the current energy usage operating period of 24 hours. In this example, the monitored discharge rate measurement is 70 kW per hour, which can be derived by dividing the 700 kW by 10 hours (predetermined time period).

At block 408, the energy management server 130 may calculate anticipated energy needs based at least upon a comparison between the monitored parameter measurement and the corresponding parameter measurement threshold. Following the example in blocks 402-406, the measured 70 kW per hour at the predetermined time period of ten hours is compared to the discharge rate measurement threshold of 50 kW per hour. Since the measured discharge rate measurement (70 kW per hour) is greater than the discharge rate measurement threshold (50 kW per hour), then this condition can trigger an adjustment in the current configuration of the mobile charging station 180(4). In one embodiment, the adjustment in the current configuration may be based upon the calculated anticipated energy needs at the time of detection of the disrupting condition.

For example, the anticipated energy needs at the end of the predetermined time period may be calculated by subtracting 700 kW from the 1200 kW to output the anticipated energy needs of 500 kW. In this example, the 500 KW is the amount of energy to be supplied by the charging station 180(4) within 14 hours, which is the remainder of the 24 hours—energy usage operating period. By dividing 500 kW of available energy by 14 hours, the adjustment in the current configuration of the mobile charging station 180(4) may include re-configuring the charging station 180(4) to discharge energy at an average rate of 35 kW per hour. In one embodiment, the remainder (i.e., 14 hours) of the 24 hours—energy usage operating period is now the second energy usage plan 140.

At block 410, the energy management server 130 may generate a second energy usage plan based upon the anticipated energy needs. Following the example in block 408, the second energy usage plan may be based on the anticipated energy needs of the mobile charging station 180(4) at the end of the predetermined time period. In the above example, the second energy usage plan may include a new discharging rate that is different from the discharging rate under the first energy usage plan.

At block 412, the energy management server 130 may store one or more new parameter measurement thresholds that are associated with the second energy usage plan. Following the example, in blocks 402-410 above, the new parameter measurement thresholds may include the 35 kW per hour.

In some embodiments, the energy management server 130 may use a different parameter measurement threshold other than the discharge rate measurement threshold as described above. For example, a capacity threshold at predetermined time periods within the energy usage operating period may be used to detect the condition that can trigger the adjustment of the initial energy usage plan. In another example, a traffic or weather threshold may be used to anticipate the projected delays due to traffic or weather conditions. In some other instances, the parameter measurement threshold may include minimum amount of charge to maintain, charging plan schedule to observe, geolocation at a particular time period, or amount of energy to transfer at a certain geolocation and/or time period.

### Example Energy Transfer Operations Between Network Components

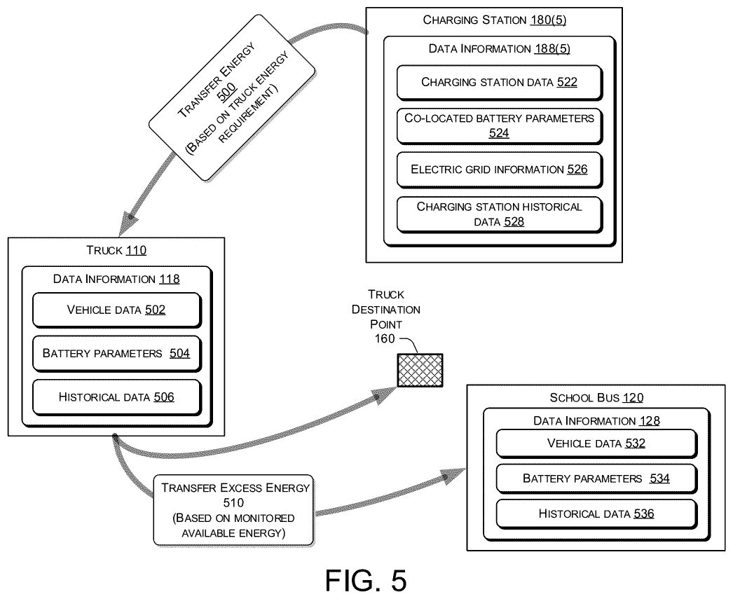

FIG. 5 is a block diagram of an example implementation of energy transfers between the network components. By way of illustration and not limitation, the energy management server 130 may be assumed to control the network components such as the charging station 180(5), truck 110, and the school bus 120 in the energy distribution network 100. In one embodiment, the energy management server 130 may receive the data information for each of these network components and the corresponding environmental data from the third-party servers (e.g., third-party servers 132). In this embodiment, the energy management server 130 may calculate the anticipated energy needs of each network component based on the corresponding data information and the associated environmental data. The calculated anticipated energy needs may then be used to generate the first energy usage plan that defines at least the corresponding configurations of the network components. In case of detected disruptions in the current configurations of the one or more network components, a recalculation of the anticipated energy needs of the affected one or more components may be performed.

For illustration purposes, the truck 110 may include the data information 118, which further includes (electric) vehicle data 502, vehicle battery parameters 504, and vehicle historical data 506. The charging station 180(5) may include the data information 188(5), which further includes a charging station data 522, co-located battery parameters 524, electric grid information 526, and charging station historical data 528. The school bus 120 may include the data information 128, which further includes (electric) vehicle data 532, vehicle battery parameters 534, and vehicle historical data 536.

Vehicle data 502, 532 may store the VIN that is unique to the truck 110 or school bus 120. They may also store the geolocation, a media access control (MAC) address of the device that is associated with the truck 110 or school bus 120, and/or other information of the truck 110 or school bus 120 such as a destination point, time of departure, expected time of arrival, operation period, and the like. The associated device of the truck 110 or school bus 120 may include an embedded electronic computer unit (ECU) or other system processors. In an example embodiment, the truck 110 or the school bus 120 may periodically transmit the vehicle data 502, 532 to the energy management server 130.

Battery parameters 504, 534 may include information about the battery of the truck 110 or school bus 120. In one embodiment, the battery parameters 504, 534 may include parameters such as capacity or state-of-charge level, depth of charge, charging and discharging rates of the battery, or the battery lifetime. The state-of-charge may include a fraction of total energy or battery capacity that has been used over the total available energy in the battery. Depth of discharge may include the fraction of power that can be withdrawn from the battery without causing serious and often irreparable damage to the battery. The charging rate may include the amount of charge that is added to the battery per unit time. Discharging rate may include the amount of charge that is taken from the battery per unit time. In an example embodiment, the truck 110 or the school bus 120 may periodically transmit the battery parameters 504, 534 to the energy management server 130. In some embodiments, the transmission may be in response to polling by the energy management server 130.

Historical data 506, 536 may include historical records that can be collected from the previous energy transfer sessions performed by the truck 110 or school bus 120. For example, the previous energy transfer sessions may include charging or discharging of energy at the charging station 180(5). Over time, the historical records may be used as training data to create a prediction model that can be used to predictively determine the distribution of energy or energy usages between the network components.

Charging station data 522 may include information about the charging station 180(5). The information can include the geolocation and identification of the charging station, MAC address of the device 186(5) that is associated with the charging station 180(5), amount of energy to supply to energy consuming devices, amount of energy to maintain, and the like. In one embodiment, the charging station 180(5) may periodically transmit the charging station data 522 to the energy management server 130.

Co-located battery parameters 524 may include information about one or more batteries that can be installed in the charging station. In one embodiment, the co-located battery parameters 524 may include parameters such as state-of-charge, depth of discharge, charging and discharging rates of the battery, or the battery lifetime.

Electric grid information 526 may include current prices or cost for charging energy via the electrical grid power source, availability of the electrical grid power source, charging and discharging rate, maximum capacity, and other information that relate to the use of the electrical power source in the charging station 180(5).

Charging station historical data 528 may include historical records collected from the previous pattern of charging or discharging of energy by the charging station 180(5). The historical records, for example, may include previous energy transfer sessions between the charging station 180(5) and other network components such as the truck 110.

In one embodiment, the energy management server 130 may receive the data information of the truck 110, school bus 120, and the charging station 180(5) to determine their respective geolocations, destination points, projected routes for the electric vehicles, number of energy consuming devices to support for the charging stations, current capacity, weight of loads for the electric vehicles, and the like. Based upon the geolocations and/or the projected routes, the energy management server 130 may poll the third-party servers to send the corresponding environmental data for each of the truck 110, school bus 120, and the charging station 180(5). In this embodiment, the energy management server 130 may then determine the corresponding anticipated energy needs of these network components. The anticipated energy needs may be used as a reference to generate the initial energy usage plan, which defines the configurations of each of the truck 110, school bus 120, and the charging station 180(5).

For example, and based upon the initial energy usage plan, the charging station 180(5) is configured to transfer energy 500 to the truck 110. The truck 110 may also be configured to travel towards the truck destination point 160 and along the way, the truck 110 may transfer excess energy 510 to the school bus 12. In this example, each configuration of the truck 110, school bus 120, and the charging station 180(5) may be based upon their respective anticipated energy needs.

In a case where the energy management server 130 detects a disruption during the energy usage operating period for the truck 110, school bus 120, and/or the charging station 180(5), then the energy management server 130 may recalculate the anticipated energy needs of the affected network component. For example, a detected unanticipated weather condition may delay the arrival of the truck 110 to the truck destination point 160. In this example, the detected condition may affect the ability of the truck 110 to transfer excess energy to the school bus 120 as described above. In this regard, the energy management server 130 may recalculate the anticipated energy needs of the truck 110 based upon the data information updates and the corresponding environmental data that can be gathered at the time of the disruption. The recalculated anticipated energy needs may then be used to adjust the initial energy usage plan.

### Example Energy Management Server

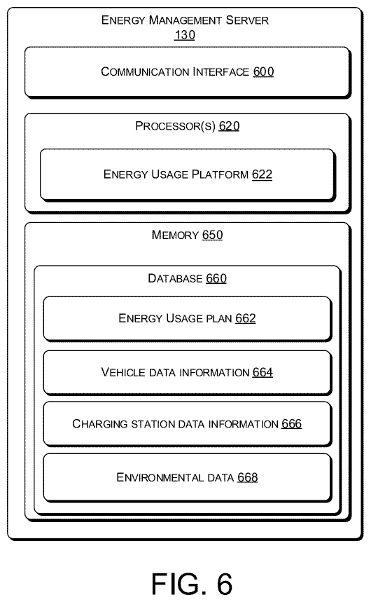

FIG. 6 is a block diagram of an example energy management server 130 that can manage the energy usage plans of the network components in the energy distribution network 100. As shown, the energy management server 130 may include a communication interface 600, one or more processors 620, and a memory 650. Processors 620 may include the energy usage platform 622. The memory 650 may include a database 660 that further includes an energy usage plan 662, vehicle data information 664, charging station data information 666, and environmental data 668.

In one example, the energy management server 130 may establish communications with the network components through the communication interface 600. The communication interface 600 may include hardware, software, or a combination of hardware and software that transmits and/or receives data from the network components throughout the energy distribution network 100. Communication interface 600 may include a transceiver that facilitates wired or wireless communications through a cellular network or the broadband network. For example, the communications can be achieved via one or more networks, such as, but are not limited to, one or more of WiMax, a Local Area Network (LAN), Wireless Local Area Network (WLAN), a Personal area network (PAN), a Campus area network (CAN), a Metropolitan area network (MAN), or any broadband network, and further enabled with technologies such as, by way of example, Global System for Mobile Communications (GSM), Personal Communications Service (PCS), Bluetooth, WiFi, Fixed Wireless Data, 2G, 5G (new radio), etc.

Processor(s) 620 may be a central processing unit(s) (CPU), graphics processing unit(s) (GPU), both a CPU and GPU, or any other sort of processing unit(s). Each of the one or more processor(s) 620 may have numerous arithmetic logic units (ALUs) that perform arithmetic and logical operations as well as one or more control units (CUs) that extract instructions and stored content from processor cache memory, and then execute these instructions by calling on the ALUs, as necessary during program execution. The one or more processor(s) 620 may also be responsible for executing all computer applications stored in the memory, which can be associated with common types of volatile (RAM) and/or non-volatile (ROM) memory. For example, the processor(s) 620 may process data information that the energy management server 130 receives through the communication interface 600. In another example, the processor(s) 620 may use the communication interface 600 to send the notifications to the network components.

The energy usage platform 622 may include hardware, software, or a combination of hardware and software that may calculate the anticipated energy needs of the network components as described herein. The energy usage platform 622 may use different types and kinds of algorithms such as K-mean algorithm, maximum likelihood algorithm, nearest neighbor algorithm, etc. to calculate the anticipated energy needs in the energy distribution network 100.

Memory 650 may be implemented using computer-readable media, such as non-transitory computer-readable storage media. Computer-readable media includes, at least, two types of computer-readable media, namely computer-readable storage media and communications media. Computer-readable storage media includes, but is not limited to, random access memory (RAM), dynamic random access memory (DRAM), read-only memory (ROM), electrically erasable programmable read-only memory (EEPROM), flash memory or other memory technology, compact disc read-only memory (CD-ROM), digital versatile disks (DVD), high-definition multimedia/data storage disks, or other optical storage, magnetic cassettes, magnetic tape, magnetic disk storage or other magnetic storage devices, or any other non-transmission medium that can be used to store information for access by a computing device. As defined herein, computer-readable storage media do not consist of and are not formed exclusively by, modulated data signals, such as a carrier wave. In contrast, communication media may embody computer-readable instructions, data structures, program modules, or other data in a modulated data signal, such as a carrier wave, or other transmission mechanisms. The memory 650 may also include a firewall. In some embodiment, the firewall may be implemented as hardware in the energy management server 130.

Database 660 may store collected data information, environmental data, historical data such as previous anticipated energy usage needs, algorithms, prediction models, and other information that can be used to calculate the anticipated energy usage needs of the network components in the energy distribution network 100. Energy usage plan 662 may store the energy usage plans that can be generated based upon the calculated anticipated energy needs of the network components. Vehicle data information 664 may store the data information of the mobile energy consuming components that can be used to calculate the anticipated energy needs. The charging station data information 666 may store the data information, parameters, geolocations, projected number of energy consuming devices to serve over a particular period, and other information that can be used to calculate the anticipated energy needs of the energy providing components. The environmental data 668 may include the characteristics of the surrounding conditions such as weather reports, traffic reports, third-party news reports, social media posting, or the like, which describe a disposition of a surrounding environment and real-time events that are occurring proximate to current geolocation or projected path of the particular network component.

Although the subject matter has been described in language specific to structural features and/or methodological acts/actions, it is to be understood that the subject matter defined in the appended claims is not necessarily limited to the specific features or acts described above. Rather, the specific features and acts described above are disclosed as example forms of implementing the claims.

What is claimed is:

1. One or more non-transitory computer-readable storage media storing computer-executable instructions that upon execution cause one or more computers to collectively perform acts comprising:
generating a first energy usage plan for a plurality of network components of an energy distribution system for a first operating period, the first energy usage plan for providing energy to energy consuming devices;
configuring energy storage systems of the network components based on the first energy usage plan;
detecting a condition that disrupts the first energy usage plan during the first operating period, wherein the condition corresponds to an inability of at least a first network component of the network components to provide energy to one or more energy consuming devices according to the first energy usage plan, and in response to detecting the condition:
generating a second energy usage plan for a remainder of the first operating period based upon the first energy usage plan and the detected condition.

2. The one or more non-transitory computer-readable storage media of claim 1, wherein the acts further comprising:
receiving data information of the network components;
determining characteristics of surrounding conditions for the first operating period;
determining anticipated energy needs for the network components for the first operating period based upon received data information and determined characteristics of the surrounding conditions; and
generating the first energy usage plan for the first operating period based at least upon the determined anticipated energy needs.

3. The one or more non-transitory computer-readable storage media of claim 2, wherein the characteristics of surrounding conditions are received via third-party servers.

4. The one or more non-transitory computer-readable storage media of claim 2, wherein the characteristics of surrounding conditions include weather conditions and traffic conditions during the first operating period.

5. The one or more non-transitory computer-readable storage media of claim 2, wherein the characteristics of surrounding conditions include weather conditions and traffic conditions that occur proximate to a geolocation of each of the network components.

6. The one or more non-transitory computer-readable storage media of claim 1, wherein the remainder of the first operating period includes a second operating period.

7. The one or more non-transitory computer-readable storage media of claim 1, wherein the first energy usage plan includes a charging plan schedule for the network components.

8. The one or more non-transitory computer-readable storage media of claim 7, wherein the second energy usage plan includes a rescheduled charging plan for the network components.

9. The one or more non-transitory computer-readable storage media of claim 1, wherein the at least one network component includes an electric vehicle or a mobile charging station.

10. A network server, comprising:
one or more processors; and
memory including a plurality of computer-executable components that are executable by the one or more processors to perform a plurality of actions, the plurality of actions comprising:
generating a first energy usage plan for a plurality of network components that are associated with corresponding energy storage systems;
generating a first energy usage plan for a plurality of network components of an energy distribution system for a first operating period, the first energy usage plan for providing energy to energy consuming devices;
configuring energy storage systems of the network components based on the first energy usage plan;
detecting a condition that disrupts the first energy usage plan during the first operating period, wherein the condition corresponds to an inability of at least a first network component of the network components to provide energy to one or more energy consuming devices according to the first energy usage plan, and in response to detecting the condition:
generating a second energy usage plan for a remainder of the first operating period based upon the first energy usage plan and the detected condition.

11. The network server of claim 10, wherein the plurality of actions further comprising:
receiving data information of the network components;
determining characteristics of surrounding conditions for the first operating period;
determining anticipated energy needs for the network components for the first operating period based upon received data information and determined characteristics of the surrounding conditions; and
generating the first energy usage plan for the first operating period based at least upon the determined anticipated energy needs.

12. The network server of claim 11, wherein the characteristics of surrounding conditions are received via third-party servers.

13. The network server of claim 11, wherein the characteristics of surrounding conditions include weather conditions and traffic conditions during the first operating period.

14. The network server of claim 11, wherein the characteristics of surrounding conditions include weather conditions and traffic conditions that occur proximate to a geolocation of each of the network components.

15. The network server of claim 10, wherein the remainder of the first operating period includes a second operating period.

16. The network server of claim 10, wherein the first energy usage plan includes a charging plan schedule for the network components.

17. The network server of claim 16, wherein the second energy usage plan includes a rescheduled charging plan for the network components.

18. A computer-implemented method, comprising:
generating a first energy usage plan for a plurality of network components of an energy distribution system based upon corresponding anticipated energy needs of the network components and for a first operating period, the first energy usage plan for providing energy to energy consuming devices;
configuring energy storage systems of the network components based on the first energy usage plan;
detecting a condition that disrupts the first energy usage plan during the first operating period, wherein the condition corresponds to an inability of at least a first network component of the network components to provide energy to one or more energy consuming devices according to the first energy usage plan, and in response to detecting the condition:
generating a second energy usage plan for a remainder of the first operating period based upon the first energy usage plan and the detected condition.

19. The computer-implemented method of claim 18, wherein the remainder of the first operating period includes a second operating period.

20. The computer-implemented method of claim 18, wherein the first energy usage plan includes a charging plan schedule for the network components.
